(19) United States
(12) Patent Application Publication
(10) Pub. No.: US 2020/0337304 A1
(43) Pub. Date: Oct. 29, 2020

(54) ANTIMICROBIAL PARTICLES AND SANITIZATION METHODS

(71) Applicant: THE REGENTS OF THE UNIVERSITY OF CALIFORNIA, Oakland, CA (US)

(72) Inventors: Nitin Nitin, Davis, CA (US); Kang Huang, Davis, CA (US)

(73) Assignee: THE REGENTS OF THE UNIVERSITY OF CALIFORNIA, Oakland, CA (US)

(21) Appl. No.: 16/871,831

(22) Filed: May 11, 2020

Related U.S. Application Data
(63) Continuation of application No. PCT/US2018/060813, filed on Nov. 13, 2018.
(60) Provisional application No. 62/585,473, filed on Nov. 13, 2017.

(51) Int. Cl. A01N 25/26; A01N 25/34; A01N 33/12; A01N 33/18; A01N 41/04

(52) U.S. Cl. CPC A01N 25/26; A01N 25/34; A01N 41/04; A01N 33/18; A01N 33/12

(57) ABSTRACT

Rechargeable antimicrobial materials that can provide continuous sanitation of contact surfaces or liquids are provided that are based on functionalized sanitization particles that are either freestanding or coupled to a surface film. The sanitization particles have a carrier particle and one or more antimicrobial agents loaded into, adsorbed onto or bonded to each carrier particle. The antimicrobial agents may also be joined to a polymer or particulates of clay or zeolite that are coupled to the carrier. Sanitization particles may also be coupled directly to a film or through a chemical linker. The particles and films provide methods of enhanced inactivation of antibiotic resistant bacteria, inactivation and dissipation of biofilms, and the reduction or elimination of bacterial pathogens from surfaces, medical devices, on food or in food containers.

### CROSS-REFERENCE TO RELATED APPLICATIONS

This application claims priority to, and is a 35 U.S.C. § 111(a) continuation of, PCT international application number PCT/US2018/060813 filed on Nov. 13, 2018, incorporated herein by reference in its entirety, which claims priority to, and the benefit of, U.S. provisional patent application Ser. No. 62/585,473 filed on Nov. 13, 2017, incorporated herein by reference in its entirety. Priority is claimed to each of the foregoing applications.

The above-referenced PCT international application was published as PCT International Publication No. WO 2019/094962 on May 16, 2019, which publication is incorporated herein by reference in its entirety.

### STATEMENT REGARDING FEDERALLY SPONSORED RESEARCH OR DEVELOPMENT

This invention was made with Government support under Grant No. 2015-68003-23411, awarded by the USDA/IFA (Initiative For Future Agriculture Food). The Government has certain rights in the invention.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to disinfection schemes for the removal of microorganisms from surfaces and liquids, and more particularly to antimicrobial particles with one or more antimicrobial agents loaded into, adsorbed onto or bound to (e.g., via covalent, ionic or hydrogen bonding) of the particles, and methods of use in reducing or eliminating bacterial pathogens and biofilms from surfaces, on food or in food containers.

### 2. Background Discussion

Population increases over the last century have greatly increased the demand for safe, healthy and ready-to-eat food products. However, bacterial contaminations remain one of the major threats to human health worldwide. For example, over 50% of the food-borne illnesses in the United States are related to the consumption of raw or minimally processed fresh produce. Similarly, a large number of recalls of poultry and meat products (over 71% of total recalls during the last 22 years) in the United States have been due to contamination with pathogenic bacteria. Microbial contamination arising from pathogens also poses the possibility of serious economic impacts arising from food losses.

Consumer demand for fresh, minimally processed vegetables and meats presents a significant challenge to the global food industry to develop antibacterial agents that are effective against a broad spectrum of microorganisms. Improvements in sanitation and washing procedures of minimally processed foods such as fresh produce and meat are vital steps for improving safety of these food products by inactivating bacteria on the surface of food products. Unfortunately, the current washing and sanitation approaches cannot achieve 4-5 log CFU/gm reduction on the surface of fresh produce and raw meat products. This limitation introduces a significant risk as fresh produce and meat products can be naturally contaminated with pathogenic bacteria. In addition, several of the food-borne illnesses resulting from minimally processed products can be traced back to cross-contamination of food products from food contact surfaces. This suggests that contamination of food contact materials with pathogenic microbes and subsequent formation of biofilms on these food contact materials can significantly enhance resistance of bacteria to standard sanitary practices in the industry.

Conventional mitigation strategies for eliminating pathogen contamination in fresh produce, poultry or meats generally include physical or chemical treatment methods. Physical disinfection methods may include ultraviolet light, ultrasound, and thermal treatments. High intensity light has been used with some success for surface de-contamination by damaging nucleic acids and interfering with replication in bacteria without creating any undesirable disinfection byproducts.

Another physical approach to the disinfection of food commodities is the use of thermal energy, such as hot water, steam or high-pressure steam. However, thermal energy is unsatisfactory because it can cause rapid deterioration of the color, texture and flavor of a food commodity and typically uses a large amount of energy.

Chemical disinfection methods typically rely on oxidation-reduction reactions to eradicate microorganisms. Common disinfectants include chlorine, chlorine dioxide, peroxyacetic acid and metal compounds. However, these disinfectants may also generate disinfection byproducts that may result in the formation of harmful secondary products.

Furthermore, some fresh foods or meats may experience detrimental changes in color, texture, acidity and other characteristics from physical treatments or prolonged exposure to chemical disinfectant environments. Therefore, some conventional techniques are not considered viable for disinfection with all types of fresh produce.

Accordingly, there is a need for materials and methods for eradicating a wide variety of microbial pests that is effective and does not leave toxic residues or alter the characteristics of the commodity that is treated and does not require the handling and storage of hazardous chemicals or the purchase of expensive machines.

### BRIEF SUMMARY

Materials and methods are provided for the targeted delivery of nanomaterial carriers that have a high affinity to bind microbes and initiate the controlled release of active compounds. The system permits the localization and sustained release of a high concentration of antimicrobial compounds to microbe surfaces thereby producing strong inhibitory and antimicrobial effects.

The system, materials and methods are particularly suited for inhibiting and dissipating biofilms. Pathogenic bacteria may form complex biofilms that are resistant to the current sanitation processes. The carriers bind to the microbial cells forming the biofilm and release the antimicrobial compounds resulting in the contact death and dissolution of the film.

The system and methods may also be applied to disinfect wash water and other liquids where the sanitizer particles have a high affinity for binding diverse microbes within the liquid and delivering antimicrobial agents to eradicate the microbes that are present. The particles may also be immobilized to different surfaces such as polymer films to provide an inhibitory surface or reactive surface to treat flowing liquids, for example.

At the center of the system is a nanoscale carrier particle with one or more antimicrobial agents loaded into, adsorbed onto or bound to (e.g., via covalent, ionic or hydrogen bonding) the carrier particle.

Alternative embodiments of the sanitizing carrier are a composite of a main carrier particle and particles of a negatively charged polymer, cellulose, clay or zeolite with one or more antimicrobial agents loaded into, adsorbed onto or bound to the polymer, cellulose, clay or zeolite components.

In various embodiments, the main carrier particle is a cell wall or fragment thereof from a fungal cell, a plant cell, an algal cell, a microalgal cell or a bacterial cell. In various embodiments, the main carrier particle is from a yeast cell. In other embodiments, the carrier particle is a bran particle or fragment thereof such as a rice bran, wheat bran or an oat bran particle.

The main carrier can be functionalized with antimicrobial agents that are directed at a specific microbe or with agents that are effective generally against a variety of microbes. The carrier may also be functionalized with several different general and specific antimicrobial agents as well.

Preferably, the antimicrobial agents are selected from the group consisting of a halamine polymer, a quaternary ammonium compound, hydrogen peroxide, metal ions, metal particles, a nitric oxide (NO) donor, an antibiotic agent and an antifungal agent.

In various embodiments, the halamine polymer is from a polymer that has been exposed to chlorine, the polymer being selected from the group consisting of poly-ε-lysine, poly-L-lysine, polyethylenimine (PEI), 2,2,6,6-Tetramethyl-4-piperidinol (TMP), and a polyamine.

In some embodiments, the NO donor is incorporated into or chemically linked to a polymer, the polymer selected from the group consisting of polyethylene glycol (PEG), polyurethane (PU), poly(methyl methacrylate) (PMMA), poly(vinyl pyrrolidone) (PVP), poly(amidoamine), poly(ethylene oxide), poly(propylene oxide), poly(vinyl chloride), polylactic acid (PLA), polyglycolic acid (PGA) and polylactic-co-glycolic acid (PLGA).

In other embodiments, a NO donor is selected from the group consisting of a nitrate compound, a nitrite compound, a nitroso compound, an S-nitrosothiol, and a diazeniumdiolate. In various embodiments, the quaternary ammonium compound is selected from the group consisting of benzalkonium chloride, cetylpyridinium chloride, cetrimonium, cetrimide, dofanium chloride, tetraethylammonium bromide, didecyldimethylammonium chloride and domiphen bromide.

In various embodiments, the quaternary ammonium salts are bound to a negatively charged polymer, a clay or zeolite part of the carrier particle. In some embodiments, the negatively charged polymer is selected from the group consisting of sodium dodecyl sulfate (SDS), phospholipids, natural polymers (e.g., carboxymethylcellulose (CMC), DNA) and synthetic polymers (e.g., polyacrylates, polystyrene sulfate, polyglutamate). In some embodiments, the polymer comprising a quaternary group comprises poly(N-alkyl-4-vinylpyridinium) bromides. In various embodiments, the metal ions are selected from copper ions and silver ions. In various embodiments, the metal ions are bound to a polymer, e.g., cellulose. In various embodiments, the metal ions are part of nanostructures.

In various embodiments, the one or more antimicrobial agents are loaded into the cell wall or bran particle bound to or associated with a polymer having a molecular weight in the range of about 0.5 kDa to about 500 kDa, e.g., e.g., at least 1 kDa to about 10 kDa, 20 kDa, 25 kDa, 30 kDa, 35 kDa, 40 kDa, 45 kDa, 50 kDa, 100 kDa, 150 kDa, 200 kDa, 250 kDa, 300 kDa, 350 kDa, 400 kDa or 500 kDa. In various embodiments, the one or more antimicrobial agents are adsorbed onto clay or zeolite, which is adsorbed onto the cell wall or bran particle.

The specifically or generally functionalized carriers may be part of antimicrobial compositions. For example, the compositions may simply comprise a population of cell wall or bran particles, as described above and herein. However, in other embodiments, the composition is in the form of an emulsion, a film, a gel, a spray coating, a dip coating, dispersion, solution, or a combination thereof. In various embodiments, the film, gel, spray coating, dip coating, dispersion, or solution, comprises multiple layers. The emulsion, film, gel, spray coating, dip coating, dispersion, or solution, preferably has a thickness in the range of about 100 nm to about 1 mm. In various embodiments, the composition is transparent.

The composition of the carriers and antimicrobial agents of the sanitizing particles that are selected may be non-toxic and may be suitable for use with a food edible by a mammal, wherein the food is wholly or partially coated with an antimicrobial composition, as described above and herein. In various embodiments, the food comprises fresh produce or meat. In various embodiments, the composition forms a continuous barrier coating on the food product.

Similarly, containers may be wholly or partially coated with an antimicrobial composition, as described herein. In various embodiments, the container is a beverage or food container. In various embodiments, the container is a plastic container or a paper container. In another aspect, provided is a food preparation surface, food processing surface, or food packaging surface, wherein the surface is wholly or partially coated with a composition, as described above and herein.

Other surfaces that may be wholly or partially coated with a composition of sanitizing antimicrobial particles may be on medical devices or bandages, for example.

Also provided are methods of reducing or eliminating bacterial and/or fungal pathogens on a surface, comprising contacting the surface with an antimicrobial composition, as described above and herein, under conditions sufficient to reduce or eliminate the bacterial and/or fungal pathogens on the surface. In some embodiments, the method further comprises the step of rinsing the composition from the surface. In various embodiments, the surface is on fresh produce or meat. In various embodiments, the surface is on a container or medical device or bandage. In various embodiments, the bacterial pathogen selected from the group consisting of Campylobacter, Helicobacter, Cholera, Cronobacter, Escherichia, Salmonella, Listeria, Lactococcus, Vibrio, Erwinia, Xanthomonas, Shigella, Staphylococcus, Streptococcus, Clostridium and Pseudomonas.

In addition, methods of making functionalized cell wall or bran carrier based sanitizing particles or a population of cell wall or bran particles is provided, as described herein. In various embodiments, the methods comprise loading into or adsorbing onto the cell wall or bran particle shell one or more antimicrobial agents. In various embodiments, the one or more antimicrobial agents are associated with or bound to a polymer. In various embodiments, the one or more antimicrobial agents are loaded into the cell wall or bran particles using one or more modalities selected from positive pressure, negative pressure, osmotic pressure, diffusion, and combinations thereof.

In one embodiment, the antimicrobial agents on the carrier can be recharged with additional antimicrobial agents after being exposed to microbes to replenish or sustain the antimicrobial activity of the sanitizing particle. For example, the chlorine presence of the particles can be recharged with bleach in some embodiments.

As used herein, the phrases “loading efficiency” or “encapsulation efficiency” interchangeably refer to the encapsulation efficiency on a wet basis determined as follows: EE (%)=C_{E}/C_{T}×100, where C_{E} is the mass of extracted antimicrobial agent from the cell wall or bran particles after encapsulation on a wet basis and C_{T} is the amount of antimicrobial agent initially added to the cell wall or bran particles.

The terms “antimicrobial agent” refers to metal ions, small organic compounds, polypeptides (e.g., ligands, antibodies), peptidomimetics, nucleic acids, small organic compounds, carbohydrates, lipids and the like, that can be encapsulated in the cell wall or bran particles described herein.

The term “hydrophobic” with respect to an antimicrobial compound refers to compounds having superior solubility in non-polar organic solvents and oils as compared to water (e.g., aqueous) and polar solvents.

The term “hydrophilic” with respect to an antimicrobial compound refers to compounds having superior solubility in water (e.g., aqueous) and polar solvents as compared to non-polar organic solvents and oils.

The terms “reducing” with reference to bacterial pathogens refers to a detectable reduction, e.g., at least about 10%, 15%, 20%, 25%, 50%, 75% or 100% reduction in bacterial pathogens.

The term “cell wall or bran particle fragment” refers to a cell wall or bran particle sufficiently intact to be loaded with or adsorbed onto one or more antimicrobial agents. In various embodiments, the cell wall or bran particle or fragment thereof is at least about 70%, 75%, 80%, 85%, 90%, 91%, 92%, 93%, 94%, 95%, 96%, 97%, 98%, 99% or 100% intact.

According to one aspect of the technology, sanitizing particles, compositions and surfaces are provided using carrier cores with one or more antimicrobial agents that are loaded into or adsorbed onto the carrier or bound to the carrier through via covalent, ionic or hydrogen bonding.

According to another aspect of the technology, methods for producing sanitizing particles, compositions and surfaces are provided that have composite carriers with a central particle with clay, zeolite or polymers coupled to the surface and the antimicrobial agents are associated with or bound to the clay, zeolite or polymer.

Another aspect of the technology is to provide sanitization methods of reducing or eliminating bacterial or fungal pathogens on a surface or in a liquid.

Still another aspect of the technology is to provide sanitization methods that includes: (i) targeted delivery of antimicrobials; (ii) localization of high concentration of disinfectants; (iii) high affinity of particles to bind diverse bacterial cells; and (iv) controlled release of the antimicrobial/sanitizer agent.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a schematic cross-sectional view of a functionalized carrier with a single type of antimicrobial agent according to one embodiment of the technology.

FIG. 2 is a schematic cross-sectional view of a functionalized carrier with adsorbed polymer or clay or zeolite particulates and two types of antimicrobial agents according to one embodiment of the technology.

FIG. 3 is a schematic process diagram for tethering functionalized particles to a film or surface according to another embodiment of the technology.

FIG. 4 is a functional block diagram of a method for sanitization with functionalized particulates according to one embodiment of the technology.

FIG. 5 is a functional diagram of graft polymerization of lignocellulose to produce halamine plant residues.

FIG. 6A is a graph illustrating inactivation of L. innocua in 3-day biofilm after 1-hour exposure: (a) metabolic activity of biofilm; (b) results of plate counting assay

FIG. 6B is a graph illustrating inactivation of E. coli O157:H7 on fresh produce surfaces after 20-min exposure to YCWPs@halamine (0.25 mg/ml).

FIG. 7A is a graph of bacterial populations on the film surface after a second contact with a control film and functionalized film showing prevention of cross contamination.

FIG. 7B is a graph of bacterial populations on the leaf surface after a second contact with a control film and functionalized film showing prevention of cross contamination of produce.

### DETAILED DESCRIPTION

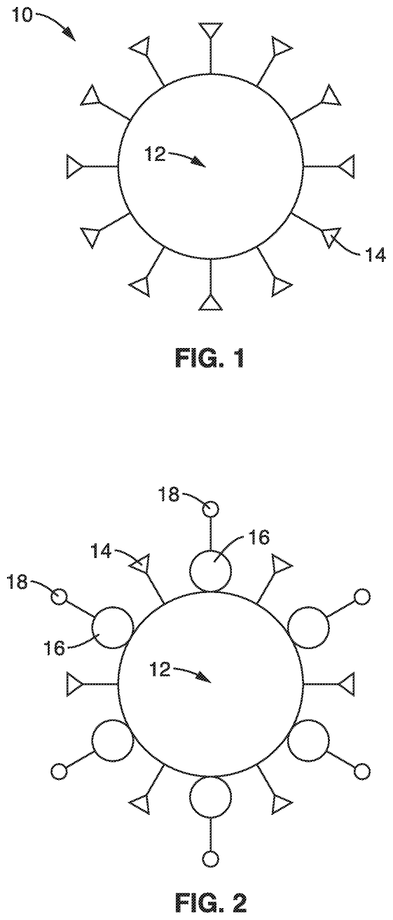

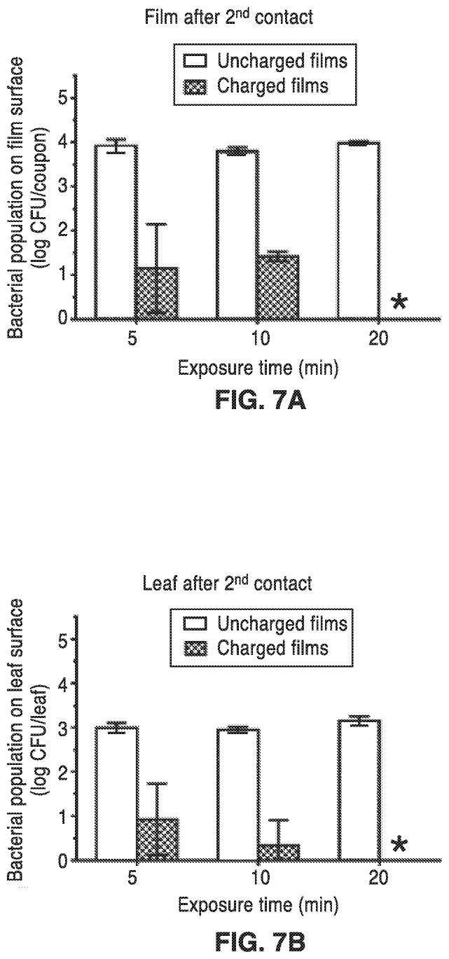

Referring more specifically to the drawings, for illustrative purposes, embodiments of an apparatus, system and methods for producing and using sanitizing particles are generally shown. Several embodiments of the technology are described generally in FIG. 1 to FIG. FIG. 7B to illustrate the controllable characteristics and functionality of the antimicrobial carrier particles and fixed carrier particles.

It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one simple embodiment of a functionalized carrier particle 10 is shown schematically in cross-section. The core carrier particle 12 has a plurality of one or more types of antimicrobial agents 14 bound to the outer surface or inner porosity of the particle 12. The antimicrobial agents 14 may be bound to the carrier 12 through covalent, ionic or hydrogen bonding or adsorbed to carrier 12 surfaces. In other embodiments, the antimicrobial agents 14 are loaded into the carrier 12 using one or more modalities selected from positive pressure, negative pressure, osmotic pressure, diffusion, and combinations thereof.

Clay or zeolite particulates or polymers 16 may also be adsorbed or bound to the core carrier particle 12 as illustrated in FIG. 2. One or more antimicrobial agents may be coupled onto the clay or zeolite particulates, which are then adsorbed onto the cell wall, bran particle or other carrier.

In the embodiment shown in FIG. 2, the core carrier 12 has a plurality of clay, zeolite or polymer particulates 16 bound to its outer surfaces. A first type of antimicrobial agent 14 is bound directly to the outer surface of the carrier 12 and a second type of antimicrobial agent 18 is coupled to the clay or zeolite particulates 16 in the embodiment illustrated in FIG. 2. Although two different types of antimicrobial agents 14, 18 are shown in the illustration of FIG. 2, it will be seen that a variety of different combinations of agents and coupling particulates 16 can be selected and coupled to the core particles 12.

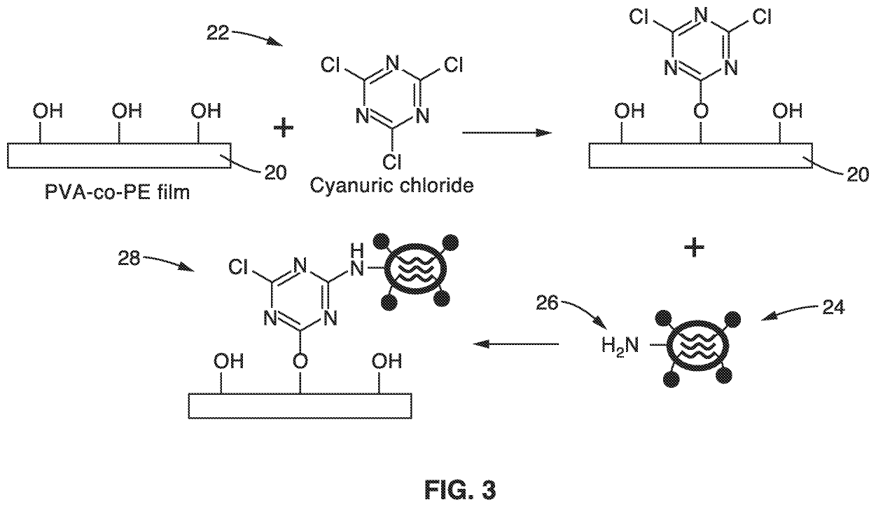

Once functionalized, the sanitizing particles may also be anchored to surfaces through a variety of known techniques to provide an inhibitory or antimicrobial film or surface. As illustrated FIG. 3, the functionalized carrier particles 24 can be immobilized to surfaces such as film 20 with a linking molecule 22. In the embodiment shown in FIG. 3, a film 20 made from a material such as (PVA-co-PE) with available alcohol moieties is prepared and placed. A chemical linker 22 such as cyanuric chloride is chemically bonded to the film 20 by reaction with the alcohol moieties. The linker 22 has available sites to bind with at least one active group 26 of the functionalized carrier particles 24 to film 20 thereby immobilizing and tethering the particle to the surface film 20. The tethered particles 24 linked to film 20 provide an antimicrobial surface coating 28 of any sized film as generally illustrated in FIG. 3. Although a linker 22 is used to tether the functionalized particle 24 in the illustration of FIG. 3, it will be understood that the functionalized sanitizing particles 24 may be anchored or adsorbed directly to the film 20.

In another embodiment, the film 20 may optionally include a base support layer that supports and protects the underside of the active film layer. The base support layer may be rigid or flexible. In another embodiment, the base support layer is a polymer material and the film layer is an active layer made from a material such as chitosan with the sanitizing particles immobilized to the chitosan active layer.

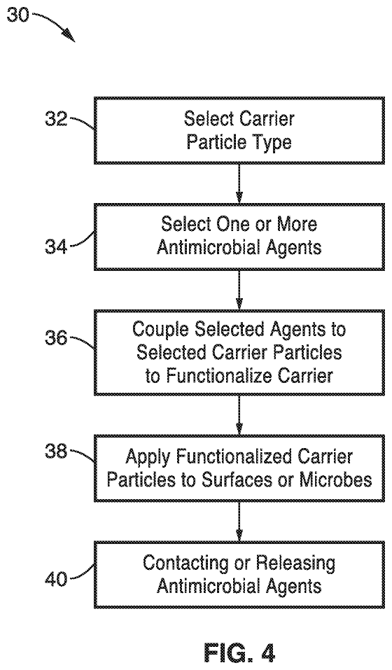

Turning now to FIG. 4, one embodiment of a method 30 for producing and using sanitizing particles for inhibiting or eliminating microbes is described. The method 30 begins generally with the formation of a functionalized carrier such as those shown in FIG. 1 or FIG. 2 that can be tailored and optimized to a specific microbe, antimicrobial activity and sanitizing applications. The fabricated particles can then be adapted for use with selected compositions and sanitizing applications.

The initial step at block 32 is the selection of a carrier particle. Carrier particles may be inorganic, organic, or biologically sourced particles that are preferably in the nanoscale to microscale size range. Carriers of cell wall or bran particles or fragments thereof are particularly preferred.

Cells having cell walls are useful for encapsulating antimicrobial agents, including polymers associated with or attached to (e.g., covalently or non-covalently) antimicrobial agents. In various embodiments, the cell wall or bran carrier particle can be a yeast cell, an algal cell, a plant cell or a bacterial cell. As appropriate, the cell wall permeability of the cell can be unmodified or modified, e.g., by exposure of the cell to a chelation agent, exposure to a reducing agent and/or by altering the cell cultivation environment (e.g., through varying nitrogen levels in the growth media and/or through supplementing cultures with CO₂).

In various embodiments, the cell wall or bran carrier particle is a yeast cell. Suitable yeast cells include without limitation, an ascomycetes cell, e.g., a Saccharomyces cell, e.g., a Saccharomyces cerevisiae cell. In some embodiments, the yeast cell is selected from the group consisting of Saccharomyces cerevisiae, Candida utilis, Lipomyces starkeyi and Phaffia rhodozyma. Other fungal/yeast cells of interest include without limitation, Saccharomyces fragilis, Fusarium moniliforme, Rhizopus niveus, Rhizopus oryzae, Aspergillus niger, Aspergillus oryzae, Candida guilliermondii, Candida lipolytica, Candida pseudotropicalis, Mucor pusillus Lindt, Mucor miehei, Rhizomucor miehei, Morteirella vinaceae, Endothia parasitica, Kluyveromyces lactis (previously called Saccharomyces lactis), Kluyveromyces marxianus, Lipomyces starkeyi, Rhodotorula colostri, Rhodotorula dairenensis, Rhodotorula glutinis, Rhodosporium diobovatum, Schizosaccharomyces pombe and Eremothecium ashbyii.

In various embodiments, the cell wall or bran carrier particle is an algal cell. Algal cells that may provide suitable carriers include without limitation, Chlorophyta (green algae), Rhodophyta (red algae), Stramenopiles (heterokonts), Xanthophyceae (yellow-green algae), Glaucocystophyceae (glaucocystophytes), Chlorarachniophyceae (chlorarachniophytes), Euglenida (euglenids), Haptophyceae (coccolithophorids), Chrysophyceae (golden algae), Cryptophyta (cryptomonads), Dinophyceae (dinoflagellates), Haptophyceae (coccolithophorids), Bacillariophyta (diatoms), Eustigmatophyceae (eustigmatophytes), Raphidophyceae (raphidophytes), Scenedesmaceae and Phaeophyceae (brown algae). In some embodiments, the algal cell is selected from the group consisting of Chlamydomonas reinhardtii, Dunaliella salina, Haematococcus pluvialis, Chlorella vulgaris, Acutodesmus obliquus, and Scenedesmus dimorphus.

In some embodiments, the green alga is selected from the group consisting of Chlamydomonas, Dunaliella, Haematococcus, Chlorella, and Scenedesmaceae. In some embodiments, the Chlamydomonas is a Chlamydomonas reinhardtii. In various embodiments the Chlorella is a Chlorella minutissima or a Chlorella sorokiniana cell. Other algal cells of interest include without limitation, Gigartinaceae and Soliericeae of the class Rodophyceae (red seaweed): Chondrus crispus, Chondrus ocellatus, Eucheuma cottonii, Eucheuma spinosum, Gigartina acicularis, Gigartina pistillata, Gigartina radula, Gigartina stellate, Furcellaria fastigiata, Analipus japonicus, Eisenia bicyclis, Hizikia fusiforme, Kjellmaniella gyrata, Laminaria angustata, Laminaria longirruris, Laminaria Longissima, Laminaria ochotensis, Laminaria claustonia, Laminaria saccharina, Laminaria digitata, Laminaria japonica, Macrocystis pyrifera, Petalonia fascia, Scytosiphon lome, Gloiopeltis furcata, Porphyra crispata, Porhyra deutata, Porhyra perforata, Porhyra suborbiculata, Porphyra tenera, and Rhodymenis palmate.

In various embodiments, the cell wall or bran carrier particle 12 is a bacterial cell. Bacterial cells of interest include without limitation Bifidobacterium cells and Lactobacillus cells (e.g., L. casei). In some embodiments, the bacterial cell is a gram negative bacterial cell, for example, an Agrobacterium tumefaciens (i.e., Rhizobium radiobacter) cell. Other bacterial cells of interest include without limitation, Bacteroides fragilis, Streptomyces natalensis, Streptomyces chattanoogensis, Streptomyces rubiginosus, Actinoplane missouriensis, Streptomyces olivaceus, Streptomyces olivochromogenes, Streptomyces griseus, Bacillus coagulans, Bacillus cereus, Bacillus stearothermophilus, Bacillus subtilis, Xanthomonas campestris, Micrococcus lysodeikticus, Acetobactor suboxydans, Lactococcus lactis, Streptococcus lactis, Streptococcus cremoris, Streptococcus lactis subspecies diacetylactis, Leuconostoc citovorum, Leuconostoc dextranicum, Lactobacillus casei, Lactobacillus fermentum, and Lactobacillus bulgaricus.

In various embodiments, bran particles may be used as carriers 12. The bran carrier particles 12 are preferably from rice bran, wheat bran or oat bran. Bran particles can be converted, e.g., to chlorine binding sanitizer particles.

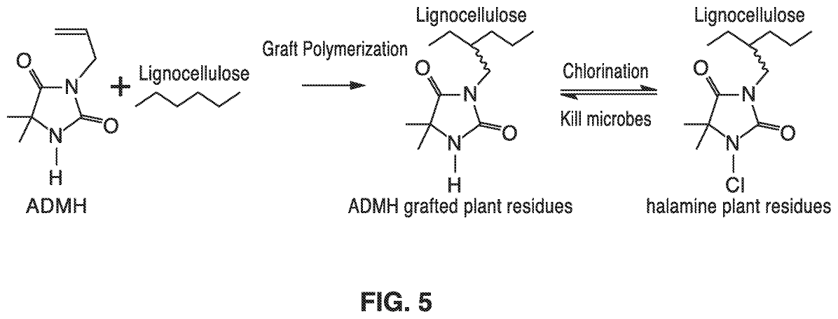

Graft polymerization of lignocellulose can be achieved by photoinitiated generation of lignocellulose radicals (using BPO, benzyl peroxide) that can further react with vinyl groups in both ADMH and PEG-DIA as illustrated in FIG. 5.

The antimicrobial agents 14 that are coupled directly to the carrier particle 12 as seen in FIG. 1, or the agents 18 that are coupled to clay, zeolites, cellulose or polymers 16 adsorbed to the carrier 12 as seen in FIG. 2, can be selected based on the type of carrier, microbe and desired antimicrobial activity.

A wide variety of antimicrobial agents 14 are available for selection at block 34 of FIG. 4. Illustrative antimicrobial agents that can be loaded into the carriers include without limitation, e.g., chlorine, metal ions, quaternary ammonium salts, hydrogen peroxide, benzoyl peroxide, nitric oxide, antibiotic agents and antifungal agents. Additional antimicrobial agents may find use, alone or associated with or bound to a polymer, clay or zeolite.

Chlorine ions have a potent antimicrobial activity. For example, polymers with amine groups can be encapsulated in the cell wall or bran particles. Illustrative polymers include without limitation poly-ε-lysine, poly-L-lysine, polyethylenimine (PEI), 2,2,6,6-Tetramethyl-4-piperidinol (TMP), and other polyamines. The polymers generally have an average molecular weight in the range of at least about 0.5 kDa to about 500 kDa, e.g., at least 1 kDa to about 10 kDa, 20 kDa, 25 kDa, 30 kDa, 35 kDa, 40 kDa, 45 kDa, 50 kDa, 100 kDa, 150 kDa, 200 kDa, 250 kDa, 300 kDa, 350 kDa, 400 kDa or 500 kDa. Once the polyamine polymers are loaded into the cell wall or bran or other carrier particles, the particles may be exposed to a sufficient concentration of bleach to form a N-halamine group, which has antimicrobial property by releasing free chlorine in water.

Metal ions or metal particles can also provide antimicrobial activity. In some embodiments, the antimicrobial agent comprises one or more metal ions or particles, e.g., silver and/or copper ions or particles. The use of silver and copper nanostructures (nanoparticles or nanowires) combined with abundant polymers such as cellulose offers an approach as a design of cheap and safe antimicrobial materials for widespread use.

In various embodiments, the cellulosic substrate can be encapsulated in the cell wall or bran particles, and then the encapsulated carrier particles can be exposed to a solution of metal ions in order to bind the metal ions to the cellulose. In some embodiments, silver and/or copper can be adsorbed on zeolites or clay and combined with carriers like cell wall or bran particles or their fragments as illustrated in FIG. 2. Also silver or copper can be in the form of nanoparticles, which can be generated in situ or added to the cell wall or bran particles, for example.

Quaternary ammonium compounds have also been shown to have antimicrobial activity. Certain quaternary ammonium compounds, especially those containing long alkyl chains, are used as antimicrobials and disinfectants. Examples are benzalkonium chloride, cetylpyridinium chloride, cetrimonium, cetrimide, dofanium chloride, tetraethylammonium bromide, didecyldimethylammonium chloride and domiphen bromide. Quaternary ammonium salts may be bound to negatively charged polymers or polyethylenimine (PEI).

Another available antimicrobial agent is hydrogen peroxide. Hydrogen peroxide is seen as an environmentally safe alternative to chlorine-based bleaches, as it degrades to form oxygen and water and it is generally recognized as safe as an antimicrobial agent by the U.S. Food and Drug Administration (FDA). H₂O₂ can be photocatalytically produced on semiconductor materials such as graphitic carbon nitride, and titanium dioxide.

Nitric oxide (NO) is a free radical that has antimicrobial activity that can be selected at block 34 of FIG. 4. Illustrative NO donors include nitrate/nitrite/nitroso compounds, S-Nitrosothiols, and Diazeniumdiolates. Polymers can be used as delivery vehicles due to their encapsulation capability and controlled release properties. Such polymers include PEG, polyurethane (PU), PMMA, poly(vinyl pyrrolidone) (PVP), poly(amidoamine), poly(ethylene oxide), poly(propylene oxide), poly(vinyl chloride), polylactic acid, polyglycolic acid and polylactic-co-glycolic acid. Polymers can be encapsulated or attached to the carrier particles and the NO donors can be incorporated into or chemically linked to polymers.

Antibiotic agents can also be selected at block 34 of FIG. 4. Illustrative antibiotics that can be bound, adsorbed or loaded into cell wall, bran or other carrier particles include without limitation quinolone antibiotics (e.g., nalidixic acid, ofloxacin, levofloxacin, ciprofloxacin, norfloxacin, enoxacin, lomefloxacin, grepafloxacin, trovafloxacin, sparfloxacin, temafloxacin, moxifloxacin, gatifloxacin, gemifloxacin), beta-lactamases (e.g., penicillin, cloxacillin, dicloxacillin, flucloxacillin, methicillin, nafcillin, oxacillin, temocillin, amoxicillin, ampicillin, mecillinam, carbenicillin, ticarcillin, azlocillin, mezlocillin, piperacillin), aminoglycosides (e.g., amikacin, gentamicin, kanamycin, neomycin, streptomycin, tobramycin), cephalosporins (e.g., cefadroxil, cefazolin, cephalexin, cefaclor, cefoxitin, cefprozil, cefuroxime, loracarbef, cefixime, cefdinir, cefditoren, cefoperazone, cefotaxime, cefpodoxime, cefepime, ceftobiprole), monobactams (e.g., aztreonam, tigemonam, nocardicin A, tabtoxinine β-lactam), carbapenems (e.g., biapenem, doripenem, ertapenem, faropenem, imipenem, meropenem, panipenem, razupenem, tebipenem, thienamycin), tetracycline antibiotics (e.g., tetracycline, chlortetracycline, oxytetracycline, demeclocycline, lymecycline, meclocycline, methacycline, minocycline, rolitetracycline, tigecycline), chloramphenicol, and triamphenicol. Additional antibiotics may find use. Macrolones, which are derived from macrolides and comprise macrocyclic moiety, linker, and either free or esterified quinolone 3-carboxylic group, can also be used in the present methods.

Other available groups of antimicrobial agents that can be selected at block 34 are antifungal or antimycotic agents. Illustrative antifungal or antimycotic agents that can be loaded into cell wall or bran particles include without limitation, polyene antifungals (e.g., Amphotericin B, candicidin, filipin, hamycin, natamycin, nystatin, rimocidin), imidazole antifungals (e.g., bifonazole, butoconazole, clotrimazole, econazole, fenticonazole, isoconazole, ketoconazole, luliconazole, miconazole, omoconazole, oxiconazole, sertaconazole, sulconazole, tioconazole), triazole antifungals (e.g., albaconazole, efinaconazole, epoxiconazole, fluconazole, isavuconazole, itraconazole, posaconazole, propiconazole, ravuconazole, terconazole, voriconazole), thiazole antifungals (e.g., abafungin), allylamines (e.g., amorolfin, butenafine, naftifine, terbinafine), echinocandins (e.g., anidulafungin, caspofungin, micafungin), and others (e.g., Aurones, Benzoic acid, Ciclopirox, Flucytosine, Griseofulvin, Haloprogin, Tolnaftate, Undecylenic acid, Crystal violet, Balsam of Peru and Orotomide (F901318)). Other known fungicides can also be loaded into cell wall or bran particles.

Once the carrier particles and one or more antimicrobial agents are selected at blocks 32 and 34, the selected antimicrobial agents are loaded on to the carriers at block 36 of FIG. 4. The selected carrier particles can be loaded with one or more antimicrobial agents using any method known in the arts.

For example, antimicrobial agents may be bound to the carrier chemically with covalent, ionic or hydrogen bonding. Antimicrobial agents can also be adsorbed onto the cell wall or bran or other carrier particles at block 36.

Other techniques useful for loading antimicrobial agents, e.g., that may be associated with or bound to a polymer, into cell wall or bran particles or other selected carrier include without limitation, positive pressure, negative pressure or vacuum, osmotic pressure, heat, diffusion, and combinations thereof. Cell wall or bran particles have relatively high porosity and have been used for encapsulation of various biomolecules and polymers.

In various embodiments, the loading of the carrier at block 36 entails subjecting a cell wall or bran particle or a population of cell wall or bran particles to vacuum pressure in the presence of one or more antimicrobial agent agents. In various embodiments, the carrier particles or a population of carrier particles are suspended in a solution that can be either aqueous or non-aqueous (e.g., 100% ethanol); isotonic, hypertonic or hypotonic to the microcapsule, and containing saturating levels of the antimicrobial agents to be loaded or encapsulated into the carrier particles.

As appropriate, the vacuum pressure (e.g., negative pressure) can be at least about 3 Torr, e.g., at least about 4 Torr, 5 Torr, 6 Torr, 7 Torr, 8 Torr, 9 Torr, and is generally less than about 10 Torr. The carrier particles are subjected to vacuum pressure for a time period sufficient to successfully load one or more antimicrobial agents into the particles.

In various embodiments, the carrier particle is subjected to vacuum pressure for less than about 30 minutes, e.g., less than about 25, 20, 15 or 10 minutes. In various embodiments, the cell wall or bran particle is sealed in a container comprising at least about 50% of absolute vacuum levels, e.g., at least about 55%, 60%, 65%, 70%, 75%, 80%, 85% or 90% of absolute vacuum levels, e.g., at least about 91%, 92%, 93%, 94%, 95%, 96%, 97%, 98% or 99% of absolute vacuum levels. The vacuum pressure applied is of a level such that the carrier particle or population of carrier particles remains substantially intact once the pressure is removed or withdrawn. That is, less than about 5% of the antimicrobial agent(s) loaded into the cell wall or bran particles are released over a period of time of 10-15 minutes under conditions of repeated washing with excess water and centrifugation.

In various embodiments, the methods comprise first subjecting the cell wall or bran or other carrier particle to vacuum pressure, and second subjecting the carrier particle to positive external pressure in the presence of one or more antimicrobial agent agents. In various embodiments, the cell wall or bran particle or a population of cell wall or bran particles is suspended in a solution that can be either aqueous or non-aqueous (e.g., 100% ethanol); isotonic, hypertonic or hypotonic to the microcapsule, and containing saturating levels of the antimicrobial agents to be loaded or encapsulated into the cell wall or bran particles.

When exposing the cell wall or bran particles to vacuum pressure followed by positive external pressure, the cell wall or bran particles can be exposed to lower vacuum pressure levels. In some embodiments, when subjecting the cell wall or bran particle to positive external pressure, the cell wall or bran particle is sealed in a container comprising at least about 50% of absolute vacuum levels, e.g., at least about 55%, 60%, 65%, 70%, 75%, 80%, 85% or 90% of absolute vacuum levels, e.g., at least about 91%, 92%, 93%, 94%, 95%, 96%, 97%, 98% or 99% of absolute vacuum levels. In some embodiments, the positive external pressure is at least about 30 MPa, e.g., at least about 35 MPa, 40 MPa, 45 MPa or 50 MPa. In various embodiments, the cell wall or bran particle is subjected to positive external pressure for less than about 90 minutes, e.g., for less than about 80, 70, 60, 50, 40, 30, 20 or 10 minutes.

The one or more antimicrobial agents can be loaded or encapsulated into the cell wall or bran particles by application of one or more iterations of vacuum pressure (and optionally including positive external pressure). For example, in some embodiments, the cell wall or bran particles can be subjected to 2, 3, 4, 5, 6, 7, 8, 9, 10 or more, iterations of vacuum pressure (and optionally positive external pressure). In various embodiments, additional antimicrobial agent is added between iterations or applications of vacuum pressure. In some embodiments, no additional antimicrobial agent is added between iterations or applications of vacuum pressure.

Generally, the loading of antimicrobial agent into the cell wall or bran particles does not comprise heating or is performed at ambient temperature. In various embodiments, the loading is performed at a temperature of less than about 38° C., e.g., less than about 37° C., 36° C., 35° C., 34° C., 33° C., 32° C., 31° C., 30° C., 29° C., 28° C., 27° C., 26° C., 25° C., but higher than freezing temperature (higher than 0° C.). In some embodiments, the loading does not comprise plasmolysing the cell wall or bran particle. In some embodiments, the methods further comprise plasmolysing the cell wall or bran particle. In various embodiments, the loaded cell wall or bran particle releases less than about 5% of the encapsulated compound. In various embodiments, the loading efficiency of the antimicrobial agent is at least about 15%, e.g., at least about 20%, 25%, 30%, 35%, 40%, 45%, 50%, 55%, 60%, 65%, 70%, 75%, 80%, 85%, or more. In some embodiments, the cell wall or bran particle is subjected to positive external pressure for less than 10 minutes, and wherein the loading efficiency of the antimicrobial agent is at least about 20%, e.g., at least about 25%, 30%, 35%, 40%, 45%, 50%, 55%, 60%, 65%, or more.

In embodiments, using zeolites or clay particles, the antimicrobial agents can be adsorbed on the surface of cell wall or bran particles or their fragments such that cell wall or bran particles retain binding properties to bacterial and other microbial targets.

The functionalized carrier particles that are produced can optionally be incorporated into emulsions, films, gels, spray coatings, dip coatings, dispersions or solutions and the like that can be applied to a surface or to microbes at block 38. The functionalized carrier particles can also be immobilized to a surface at block 38 as illustrated in FIG. 3.

In various embodiments, the antimicrobial compositions for encapsulation and controlled release of antimicrobial agents can be provided in the form of an emulsion (e.g., a water-in-oil emulsion or a water-in-oil-in-water emulsion), a film, a gel, a spray coating, a dip coating, dispersion, solution, or a combination thereof. The emulsions, films, gels, spray coatings, dip coatings, and combinations thereof find use in protecting desired surfaces from bacterial contamination (e.g., biocontrol).

In various embodiments, the surfaces desired to be protected are on food, on food containers (including beverage containers), and on wipes, sanitary products, wound dressings, and medical devices. For cell wall or bran particle compositions to be used in coating and disinfecting food, the antimicrobial agent is in a form and concentration that is edible by a mammal.

In some embodiments, compositions in the form of solutions, dispersions of particles, foams, misting, and sprays can be used to make direct contact on the target surfaces, e.g., food or food contact surface or skin. In some embodiments, after treatment, the surface can be rinsed or treated to remove the antimicrobial-loaded cell wall or bran particles. In some embodiments, compositions comprising the antimicrobial-loaded cell wall or bran particles are sprayed directly on plants, e.g., in the field or in a green house.

In one embodiment, the edible composition is a dip coating comprising whey protein isolate (WPI), glycerol and beeswax. Illustrative concentrations of these components are as follows: 10% w/v (total solution) whey protein isolate (WPI), glycerol at 33% w/w WPI, and beeswax at 20% w/w of WPI+glycerol.

The application of functionalized carrier particles or compositions at block 38 of FIG. 4 can be a temporary contact or can result in the formation of a coating of particles on a surface. Antimicrobial coatings can be applied wholly or partially to a wide variety of surfaces at block 38.

For example, the applied functionalized particle composition can form a continuous barrier coating on food or a food container. In some embodiments, the food comprises fresh produce or meat. Illustrative produce that can be protected using the present compositions includes, without limitation, e.g., apples, cucumbers, lettuce, carrots, tomatoes, spinach, broccoli, cantaloupe, strawberries and onions. The fresh produce may include intact food material or cut fresh produce. In various embodiments, the meat is selected from beef, pork, lamb, chicken, turkey, and seafood, including fish. In some embodiments, when used to coat or treat food, the food can be rinsed or treated to remove the antimicrobial-loaded cell wall or bran particles.

In some embodiments, the coated surfaces are of containers such as food or beverage containers. In various embodiments, the container is a glass container, a metal container, a plastic container or a paper container (e.g., a waxed paper container). In various embodiments, the container is Styrofoam. In some embodiments, the container is a personal products container (e.g., containing a product for topical application, e.g., shampoo, lotion, cream, toothpaste, etc.).

Coatings of functionalized particles can also be applied to medical devices and wound dressings to provide an inhibitory coating to the surfaces. For example, the present compositions can be coated onto an external plastic and/or metal surface of a medical device. Illustrative medical devices that can be coated with the present compositions include, suture thread, wound closure tape, catheters, tubes, stents, arthroscopic balloons, pace makers, replacement joints (e.g., hip, knee), valves, chips (e.g., information storage media, computer chip, computer-readable media), etc. For certain embodiments of medical applications, the carrier particles can be loaded with antibiotic and/or antifungal agents.

At block 40 of FIG. 4, the antimicrobial agents of the functionalized particles are brought in contact with microbes resulting in the elimination of pathogens by contact or in the local release of antimicrobial agents. The sanitizing particles may optionally be removed after a period of contact at block 40. The carriers may also be recharged with additional antimicrobial agents after contact with the microbes at block 40 in another embodiment.

In various embodiments, the methods at block 40 further comprise the step of contacting the target with an external stimulus (e.g., an aqueous solution, moisture, light and biodegradation (e.g., including digestion processes in the gut)) to activate or release the antimicrobial agent. Concurrent release of non-crosslinked material (e.g., non-cross-linked polymer and plasticizer) from the compositions (e.g., in the form of films or coatings) can be achieved by swelling, degradation and/or erosion of the polymer matrix. In various embodiments, swelling of film matrix can be induced, triggered or promoted by exposure to surface moisture or an aqueous solvent (e.g., water). The swelling of the matrix and concurrent release of non-crosslinked material (e.g., non-cross-linked polymer and plasticizer) induces and promotes release of antimicrobial agents. Biodegradation of the polymer matrix also induces and promotes release of encapsulated antimicrobial agents. Biodegradable properties of the polymer can be particularly useful for antimicrobial coatings on medical implants. In various embodiments, the polymer matrix can be degraded by external stimuli such as light.

Accordingly, the methods reduce or eliminate microbes such as bacterial pathogens on surfaces by transiently contacting the surface with functionalized particles or by forming a coating on the surface. The present compositions find use as a biocontrol material formulation that is stable under ambient conditions but provide an efficient antimicrobial activity against specific pathogens in complex environments including food and agriculture. In various embodiments, the biocontrol material can be used for sanitation of food or food contact materials. Similarly, it can be used for skin, hair and oral products.

The technology described herein may be better understood with reference to the accompanying examples, which are intended for purposes of illustration only and should not be construed as in any sense limiting the scope of the technology described herein as defined in the claims appended hereto.

### Example 1

To demonstrate the operational principles of the functionalized carrier particle materials and methods for production, cell wall and bran carrier particles were physically and chemically coupled with several types of antimicrobial agents and evaluated. In this example, carriers of particles of bran, yeast cell walls, bacterial cell walls and fungal cell walls were prepared and paired with antimicrobial agents. The antimicrobial agents that were evaluated were chlorine, metal ions, Quaternary ammonium salts, hydrogen peroxide, graphitic carbon nitride and nitric oxide.

The cell wall particles were generated from raw material by one of several processes including chemical (e.g. acid and or base) treatments, biochemical (e.g. enzymes) and physical modifications (e.g. heat, ultrasound) and their combination. The raw materials were spent cells from fermentation processes, cultured cells, and plant cell wall or bran particles were obtained from vegetable peels and agricultural biomass.

Chlorine microbial agents were demonstrated with carriers of yeast cell wall (YCWPs) or bran particles and polymers. Polymers with an amine group were encapsulated in the YCWPs selected from the group of polymers of poly-e-lysine, poly-L-lysine, polyethylenimine (PEI), 2,2,6,6-Tetramethyl-4-piperidinol (TMP), and polyamines. Then, the encapsulated YCWPs were exposed to 1% bleach to form a N-halamine group, which has antimicrobial property by releasing free chlorine in water.

In another illustration, polyethylenimine (PEI) was coupled to yeast cell wall or bran carrier particles. Yeast cell wall and bran particles have relatively high porosity and can be used for encapsulation or association of various biomolecules and polymers. In this illustration, osmotic pressure was used to infuse PEI polymer with a MW about 25 KDa. In other cases, a simple diffusion processes or heat/pressure assisted diffusion into cell wall or bran particles was used. In one of the pressure applications, encapsulation was carried out by negative pressure facilitated infusion of PEI. Prior to vacuum application, 0.5 g of dry cell wall or bran particles were mixed with 3.25 ml 100 mM phosphate buffer, pH=6.5. After vortexing, 1 ml of ethanol and 0.75 ml of PEI (200 mg/mL in ethanol) were added. After initial incubation, vacuum pressures of 99% vacuum were used for 5 mins to increase infusion. After infusion, the suspension was incubated at room temperature for 10 min, centrifuged, and then washed three times in DI water and stored for use.

The infused carrier was then chlorinated to charge the carrier. See also FIG. 5. A chlorination solution with active chlorine of 1.5 wt % was prepared by diluting the bleach solution, and the pH of the chlorination solution was adjusted to pH=5. Typically, 0.5 g of YCWP-PEI particles were suspended in 50 ml of chlorination solution with shaking for 1 h. Then the particles were washed three times by centrifuge to remove any free hypochlorous moieties.

The use of silver and copper nanostructures (nanoparticles or nanowires) combined with abundant polymers such as cellulose was evaluated as a possible cheap and safe antimicrobial materials for widespread use. The cellulosic substrate was encapsulated in the YCWP particle carriers, and then exposed to a solution of metal ions to bind the metal ions with cellulose. The cellulose encapsulated YCWPs mixed with the solution of metal ions was kept under constant stirring, at room temperature, for over 3 hours. The resulting composites were collected by centrifuge and thoroughly washed with distilled water.

Quaternary ammonium compounds have also been shown to have antimicrobial activity. Certain quaternary ammonium compounds, especially those containing long alkyl chains, can be used as antimicrobials and disinfectants. Examples are benzalkonium chloride, cetylpyridinium chloride, cetrimonium, cetrimide, dofanium chloride, tetraethylammonium bromide, didecyldimethylammonium chloride and domiphen bromide. The quaternary ammonium salts can be bound directly to the YCWP carrier or the salts may be bound to negatively charged polymers added to the YCWP or other carriers.

Hydrogen peroxide was also evaluated. Hydrogen peroxide is seen as an environmentally safe alternative to chlorine-based bleaches, as it degrades to form oxygen and water and it is generally recognized as safe as an antimicrobial agent by the U.S. Food and Drug Administration (FDA).

Graphitic carbon nitride (GCN) can be made by polymerization of cyanamide, dicyandiamide or melamine. The firstly formed polymeric C₃N₄ structure, melon, with pendant amino groups, is a highly ordered polymer. Further reaction leads to more condensed and less defective C₃N₄ species, based on tri-s-triazine (C₆N₇) units as elementary building blocks. GCN-encapsulated YCWPs were successfully activated by the irradiation of visible light (˜480 nm) and exhibits high photocatalytic activity for H₂ or O₂ evolution from water.

Finally, nitric oxide was also paired with a carrier and evaluated. Nitric oxide (NO) is a free radical that has antimicrobial activity. The NO donors include Nitrate/nitrite/nitroso compounds, S-Nitrosothiols, and Diazeniumdiolates. Polymers can be used as delivery vehicles by virtue of their encapsulation capability and controlled release properties. Such polymers include PEG, polyurethane (PU), PMMA, poly(vinyl pyrrolidone) (PVP), poly(amidoamine), poly(ethylene oxide), poly(propylene oxide), poly(vinyl chloride), polylactic acid, polyglycolic acid and polylactic-co-glycolic acid. Polymers can be encapsulated in the YCWPs and the NO donors can be incorporated into or chemically linked to polymers.

### Example 2

The antimicrobial activity of yeast cell wall or bran particles, as illustrative of cell wall or bran particles generally, encapsulated with halamine (YCWPs@halamine), an illustrative antimicrobial agent, was demonstrated by inactivating bacteria in simulated wash water, biofilm bacteria, and bacteria on fresh produce surface, respectively.

The activity and inactivation of bacteria in simulated wash water exposed to the functionalized particles and conventional chlorine sanitizers were evaluated and compared. More than a 5-log reduction of Listeria innocua in wash water was obtained after a 0.5-min exposure to YCWPs based sanitizer at the concentration of 0.1 mg/mL. In comparison, the conventional chlorine-based sanitizer (sodium hypochlorite) needed 1.5 min to achieve a 5-log reduction. In the presence of organic matter (COD=2000 mg/L), more than 5 log reduction of Listeria innocua in wash water was obtained after 5 min exposure to YCWPs based sanitizer. The conventional sanitizer (sodium hypochlorite, 20 ppm free chlorine) did not reduce the bacterial population in wash water after 20 minutes of exposure.

The inactivation of biofilm forming bacteria by exposure to functionalized particles was also evaluated to illustrate the potential of yeast cell wall or bran particles encapsulated or adsorbed with halamine (YCWPs@halamine) to inactive a 3-day cultured biofilm on a plastic surface. The antimicrobial activity was characterized based on the metabolic activity of the biofilm measured using Resazurin and a plate counting assay.

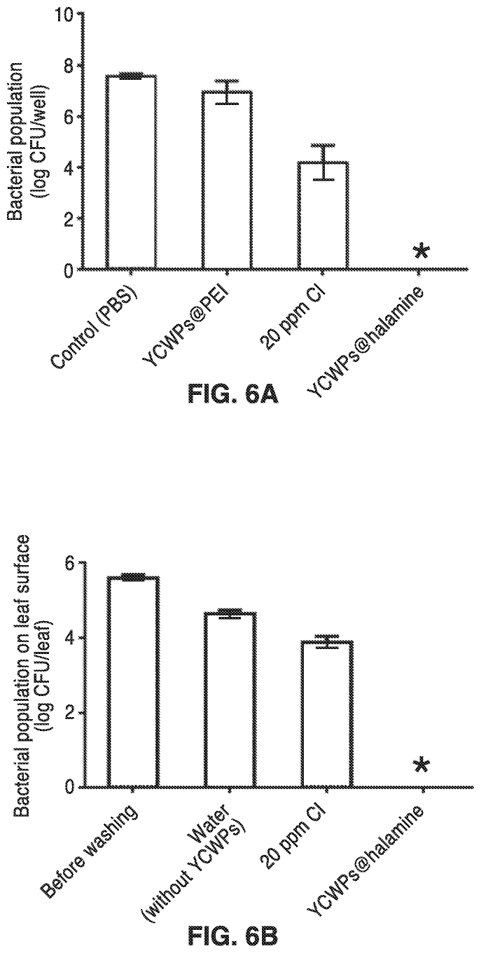

The metabolic activity of biofilm after a 1-hour exposure to the particulate sanitizer was evaluated. The time required to achieve maximum fluorescence intensity indicated the relative level of metabolic activity of bacterial cells under different incubation conditions. Listeria biofilms that were incubated with PBS were treated as a control. The metabolic activity of biofilm treated by the carrier-based sanitizer reduced significantly, when compared to control and conventional sanitizer treated samples. The results of the plate counting assay indicated that the YCWP particle-based sanitizer was able to achieve more than a 7-log reduction of the bacterial population in the 3-day biofilm as shown in FIG. 6A. The conventional sanitizer (sodium hypochlorite) only achieved 3-log reduction after a 1-hour exposure.

In addition, the ability of YCWPs based carriers to bind with bacterial cells and a 3-day L. innocua biofilm was evaluated. The results showed a significant binding of the bacteria with functionalized yeast cell carriers. The yeast cell wall or bran particles were stained by Calcofluor white dye. The results highlight high affinity binding that further enhances the influence of the particle sanitizers associated with yeast cell wall carriers. It was observed that after incubation of yeast cell wall or bran particles with L. innocua biofilm for 1 hour, more than 20% of yeast cell wall or bran particles adhered to the biofilm. The affinity of YCWPs can be further modified based on the method of preparation.

The inactivation of bacteria on fresh produce surfaces was also evaluated. These YCWPs based sanitizer was also found to be effective in causing more than 5 log reductions in E. coli O157:H7 on the surface of lettuce leaves as shown in FIG. 6B. The conventional chlorine-based sanitizer (sodium hypochlorite, 20 ppm free chlorine) achieved less than 2-log reduction of the inoculated bacteria.

The effect of sanitation process on the quality of fresh produce was evaluated by total color difference and texture of lettuce leaves. No significant difference was observed between untreated and YCWPs based sanitizer-treated leaves, while the conventional sanitizer significantly changed the color of the leaves. The maximum compression force was used to quantify the texture analysis of lettuce leaves. Also, no significant difference was observed after 20 minutes of washing by the YCWPs based sanitizer.

### Example 3

To further demonstrate the operational principles of the materials and methods, yeast cell wall or bran carriers and silica carrier particulates were prepared, functionalized and evaluated. The yeast cell wall or bran particles were prepared by three complementary methods (a) autolysis with incubation at high temperature of 55° C. for 24 hours; (b) mechanical approach for lysing the cells such as French press; and (c) acid and base hydrolysis of yeast cells.

For the autolysis process, yeast cell strains were autolyzed after an initial culturing for 48 hours under optimal cell culture by incubating at pH 5 at a temperature of 50° C. for 24 hours and centrifuged (17700×g, 10 min) to separate cell wall or bran particles from the supernatant.

For the French press approach, the selected yeast strains were lysed after initial culturing by the application of pressure in a French press at 20,000 psi. After pressure assisted lysis, the cell wall or bran particles were isolated using centrifugation.

In addition to these two approaches, yeast cell wall or bran particles (YCWPs) were prepared using the base and acid hydrolysis methods. Briefly, 20 g yeast cell mass was suspended in 200 mL of a 1M NaOH solution to yield a 10% (w/v) suspension of yeast. The suspension was heated to 80° C. and stirred for 1 hour. After cooling and decantation, the cell suspension was suspended in the acidic solution at pH 4.2 and then suspension was heated to 55° C. for 1 hour. The yeast cell wall or bran particles were isolated by centrifugation.

Encapsulation of PL-polymer in some yeast cell wall or bran carrier particles was performed.

Since yeast cell wall or bran particles have relatively high porosity, monomers/polymers may be encapsulated, adsorbed or otherwise associated with the particles as possible antimicrobial attachment points. In this approach, osmotic pressure was used to infuse a PL polymer with a MW˜50 KDa. Encapsulation was carried out by negative pressure facilitated infusion of PL polymers. Prior to vacuum application, dry cell wall or bran particles were mixed with a volume of PL compounds (10 mg/mL in 50 mM Tris HCl pH 8, 2 mM EDTA, and 0.15 M NaCl (TEN)) to minimally hydrate the particles and incubated for 2 hours to allow the particles to swell and adsorb the compounds. PL adsorption was allowed to proceed for at least 1 hour. After initial incubation, vacuum pressures of 99% vacuum were used for 5 mins to increase infusion. After infusion, the suspension was centrifuged, and then washed three times in 0.9% saline and stored for use.

Silica carrier particles were also prepared with a modified Stober method as this approach provides monodisperse silica particles and control over the size of the silica particles. Solution I was prepared with water (6.75 ml), ethanol (65 ml), ammonia (9 ml) and KCl electrolyte (0.017 g). Solution II was prepared with TEOS (3.95 g) and ethanol (33.3 ml). Solution I was then added to the reaction flask and thereafter solution II was added into the flask continuously by a syringe pump (0.2 ml/min) over 3 hours. After further reaction (300 rpm, 30° C.) for 15 hours, the obtained microparticles were purified by centrifugation and washed with ethanol three times.

Using this approach, silica particles with particle diameters of 1, 10, and 100 microns were synthesized by varying the ratio of precursors in the solution I and solution II (particularly TEOS, ethanol and ammonia concentrations). The obtained silica particles were dried under vacuum at ambient temperature. Dried silica particles (10 mg) were suspended in 10 ml of 0.6 M sodium carbonate solution (activation buffer) for 15 minutes by ultrasonication. The suspension was centrifuged to remove the supernatant. Activated silica particles were resuspended in 10 ml of PBS buffer (pH 7.4) for 20 min by ultrasonication. Poly-lysine (PL) (80 nmol) was added dropwise to the particle suspension with continuous stirring for 21 hours at 4° C. PL-modified silica particles were washed several times with DI water, and then resuspended in 10 ml of DI water and stored at 4° C.

Some of the prepared carrier particles were chlorinated with a chlorination solution with active chlorine of 1.5 wt % that was prepared by diluting a bleach solution and adjusting the pH of the solution to pH=5. Typically, 1 g of PL-silica particles were suspended in 100 ml of chlorination solution with shaking for 1 h. The particles were washed for three times by centrifuge to remove any free hypochlorous moieties.

The total chlorine content on particles was measured using an iodine titration method. 0.1 g of charged particles were added to 15 ml of 0.001 N sodium thiosulfate solution with shaking for 30 min. The residual sodium thiosulfate was subsequently titrated with a 0.001 N iodine standard solution. The active chlorine content (ppm) of the samples was calculated according to 34.45×(V₀−Vs)×500/m, where V₀ and Vs are the volumes (mL) of the iodine solution consumed in titration without and with charged particles, respectively; m is the weight (g) of the particles.

Free chlorine content that is released to water was quantified using a colorimetric assay. After chlorination and washing, 0.004 g of PL-silica particles was resuspended in 2 ml of DI water, to which 100 μl of the DPD reagent (Hach, Loveland, Colo.) was applied. The solutions containing the particles were shaken for 20 min for color generation, and the absorbance was measured at 512 nm. Free chlorine content was determined from a standard curve prepared with multiple chlorine concentrations.

Yeast derivatives such as yeast cell wall or bran particles have been shown to bind enteropathogenic bacteria such as E. coli and Salmonella spp. This binding is mediated by range of factors including mannan and galacto oligosaccharides (MOS) for the binding of pathogens via mannose or galacto specific type-I fimbriae or lectins; multivalent interactions of polysaccharides glucans and other interactions among yeast cell walls and diverse pathogenic bacteria. In addition to unique surface active ligands for binding bacteria, the yeast cell wall or bran particles are a versatile encapsulation carrier that can be used to deliver diversity of biomolecules and polymers. For total mannan and glucan determination, yeast cell wall polysaccharides were hydrolyzed with sulfuric acid for 18 hours. To remove interfering proteins and fats, the hydrolysate was precipitated by divalent metal ion as zinc (2+) and/or cyanoferrate (II)—complexes. The cleared supernatants were analyzed for glucose and mannose by HPLC-RID using an ICSep ION-300 column.

### Example 4

Binding assays were performed to quantify binding of the yeast cell wall or bran carrier particles isolated from different strains to pathogenic bacteria. The binding of pathogenic bacteria to yeast cell wall or bran particles that were adsorbed on the surface of a microplate was measured. In this approach, the yeast cell wall or bran particles were absorbed on the microplate by extended incubation for 24 hours at 4° C. The excess yeast cell wall or bran particles were rinsed from the plate surface. After rinsing, the microtiter plate was incubated with a fixed concentration (OD of 0.01) of selected pathogenic bacteria strains. After 5 minutes of incubation, the excess bacteria were removed by serial rinsing and terrific broth media was added to the microplate wells. The microplate was incubated at 37° C. for 12 hours in a plate reader and the cell growth of bacterial cells retained in the microplate by binding to yeast cell wall or bran particles were measured. Gram-positive strains of Listeria monocytogenes and gram-negative strains of Escherichia coli and Salmonella spp were selected as model pathogenic bacterial strains. In addition, strains of L. monocytogenes, E. coli, and Salmonella spp. with multi-drug resistance were selected as model antibiotic resistant strains.

To evaluate the efficacy of particle treatments to inactivate pre-formed biofilms, a culture of selected strains of bacteria diluted to a final concentration of 1×10⁷ CFU/mL in a 10% (v/v water) solution of M9 minimal salts medium with 0.4% glucose and 0.4% tryptone were incubated for 24 hours at room temperature. After incubation, the planktonic cells were removed by rinsing the surface with sterile water. Anti-biofilm treatment efficacy was quantified based on a combination of colorimetric staining using the crystal violet assay as well as metabolic activity of the biofilm measured using the fluorescent resazurin dye. This combination of approaches provided a comprehensive assessment of the total biomass on the surface as well as the viability of bacterial cells within the biofilm. This assessment was complemented with SEM (scanning electron microscopy) imaging.

Binding activity of selected particle-based carriers to biofilms was evaluated. Non-charged particles (without chlorine addition) of silica, alginate hydrogel beads and yeast cell wall or bran particles were incubated with selected biofilms for 5 minutes and 10 minutes. After incubation, the samples were rinsed to remove any unbound particles. Binding of the yeast cell wall carriers and alginate-based carrier particles were characterized based on fluorescence signal intensity. For these measurements, both the yeast cell wall or bran particles and alginate beads were chemically labeled with the same near-infrared fluorophore to reduce contributions from the biofilm background using a standard bioconjugation process. Before incubation, the fluorescence concentration of the particles was quantified using a plate reader and after incubation, the resulting fluorescence signal was quantified using both widefield imaging microscopy and plate reader measurements. In the case of silica particles, the concentration of silica in biofilms was measured using the standard ICP-OES (inductively coupled plasma-optical emission spectroscopy). Based on these binding measurements and the total loading of chlorine per weight of the particle, the optimal particle-based carrier for inactivation of biofilms was selected.

To model attachment of microbes on food contact surfaces, selected strains of bacteria, yeast or mold at concentration levels of 10⁷ CFU/mL would be incubated on a selected surface for 3 hour both with and without simulated organic content (sterile rehydrated nonfat dry milk-100 g milk solids/liter, was used as simulate organic matter contamination on food contact surfaces). After incubation, the surface was rinsed to remove loosely attached bacteria. The surface was then rinsed with either the selected particle-based sanitizer or the conventional sanitation procedure for the sanitation of food contract surface. For this comparative evaluation, the concentration of conventional sanitizer, such as free chlorine content, was matched with the free chlorine content generated by the ppm levels of particle-based sanitizers. The concentration levels of particle-based sanitizers were optimized to match the levels of 2, 5 and 10 ppm of free chlorine used in conventional sanitation. Quantification of the treatment was assessed based on the standard surface swabbing method to sample the attached bacteria to the surface and their quantification using the plate counting and culturing method.

Pre-formed biofilms were treated with either a selected particle-based sanitizer or with a conventional sanitation procedure for the sanitation of a food contract surface. For this comparative evaluation, the same sanitation procedure as outlined above for the treatment of surface adsorbed bacteria was used. Quantification of the treatment was assessed based on measuring the changes in the metabolic activity of bacterial cells. Quantification of the residual biomass was conducted using crystal violet staining and calcofluor labeling and the standard plate counting of the bacterial cells after dispersing the biofilms using an ultrasonic washer.

The results demonstrated the potential of ppm concentrations (1 mg/ml) of yeast cell wall or bran particles encapsulated with halamine (YCWPs@halamine) to inactive a 3-day cultured biofilm on a plastic surface.

### Example 5

The antimicrobial activity of functionalized yeast cell wall or bran carrier particles with halamine (YCWPs@halamine) as an antimicrobial agent, was further demonstrated by inactivating bacteria on fresh produce and poultry surfaces. The effect of sanitation process on the quality of fresh produce was also evaluated by total color difference and texture of lettuce leaves, for example.

Binding of the yeast cell wall or bran particles to bacteria inoculated on the surface of model food systems was evaluated. For these assays, fresh produce and chicken breast meat samples were selected. These model food systems were inoculated with pathogenic bacteria, labeled with a nucleic acid based fluorescent dye such as Sybr green. The yeast cell wall or bran particles were fluorescently labeled with cell wall binding dyes such as Calcofluor blue. Bacterial strains are shown in Table 1.

To inoculate fresh produce, samples (e.g., spinach, lettuce, tomato, and orange) were first rinsed with 70% ethanol and dried at 25° C. before sample preparation. Fresh produce samples were then prepared by cutting spinach and lettuce leaves into disks with 1 cm of diameter and tomato and orange skins into squares of 9 cm². Bacterial inoculation was performed by spotting 0.1 mL of freshly grown bacterial suspensions with bacterial concentration of 1.0×10⁷ and 10⁵ CFU/mL to the center of each fresh produce sample and carefully spreading the bacteria across the entire surface. The inoculated samples were left to dry at 25° C. for up to 30 min in order to ensure bacterial attachment.

To inoculate meat samples, chicken breast meat samples were first rinsed with 70% ethanol and left in air for drying. Then the meat was cut into squares of 3×3 cm². Bacterial inoculation was performed using a similar procedure as used for the fresh produce samples.

After inoculation and incubation, the meat and fresh produce samples were transferred to a simulated wash bath with added particle-based sanitizers. The concentration level of the functionalized particles (in the ppm range) were matched to achieve the free chlorine content of 5, 10 and 15 ppm respectively in a simulated wash environment. The samples were exposed to simulated sanitation process with suspended organics to mimic range of COD conditions (COD levels of 0, 500, 1000 and 2000) during conventional sanitation of fresh produce and meat. The samples were stirred in a shaking bath a speed of 250 rpm for a pre-determined period (1, 2, 5, and 10 min). After each treatment, the samples were removed by sterile forceps and rinsed twice by sterile DI water to remove the loosely adhered bacterial cells.

To quantify the reduction in microbial count, the samples after treatment were transferred to sterile tubes containing silicon-carbide beads and 10 mL of PBS, and vortexed for 60 seconds to recover the attached bacteria. The samples were then serially diluted in sterile PBS and plated on selective mediums for the standard plate counting.

Yeast cell wall or bran particles with halamine achieve greater than 5 log reductions in inoculated bacteria on lettuce leaves: In one evaluation, yeast cell wall or bran particles (YCWPs) were used as a carrier to encapsulate halamine compounds in bio-based particles. The cationic polymer polyethylenimine (PEI) was also encapsulated in YCWPs. After 1 h of chlorination in 1° A bleach, the total active chlorine content on the YCWPs was more than 4000 ppm.

The antimicrobial activity of YCWPs@halamine was demonstrated by inactivating bacteria in simulated wash water and on fresh produce surfaces, respectively. More than a 6-log reduction of E. coli O157:H7 in wash water was obtained after a 5-min exposure to YCWPs based sanitizer at the concentration of 0.25 mg/m I. These bio-based particles were also found to be effective in causing more than 5 log reduction in E. coli O157:H7 on the surface of lettuce leaves. The conventional washing process achieved less than 2 log reduction of the inoculated bacteria. It was shown that the strains of yeast that have high affinity for binding target pathogens.

It was also shown that localized high concentrations of sanitizers on silica particles achieves greater than 5 log reduction of E. coli O157:H7 on lettuce leaf surfaces illustrating improvement in sanitation of fresh produce surfaces using food grade silica particle-based sanitizers. In this case, ppm levels of silica particles functionalized with chlorine binding halamine groups were used. The effective sanitizer concentration in the bulk solution was equivalent to 5 ppm of free chlorine added during a conventional sanitation process, although the total active chlorine content bound to the particle surface was approximately 500 ppm. During a simulated washing process, the ppm concentration of silica particles functionalized with chlorine binding groups on its surface achieves greater than 5 log of E. coli O157:H7 on the produce surface with 10 minutes of mechanical agitation of wash water. The controls (5 ppm of free chlorine in a simulated produce washing) for the same experimental conditions achieved less than 2 log reduction of the inoculated bacteria, while the silica particles by themselves did not inactivate microbes. The time period required for achieving 5 log reduction can be further optimized by further improving the design of particles such as particle size and their concentration in a wash solution.

It was also shown that mechanical agitation enhances contact of particles with the leaf or meat surfaces. Movement of particles in wash water even at sub-ppm concentration levels significantly increased the level of mechanical shear experienced by bacteria attaching to leaf surface (avg. fivefold increase) and enhances removal of the bacteria from the leaf surface.

In summary, these results suggest that a synergistic combination of mechanical agitation and a localized high concentration of sanitizers on the surface of particles improves contact of sanitizers with food materials and in turn enhances bacterial inactivation. This is of high significance as many varieties of fresh produce and meat products may have a hydrophobic layer on the surface such as fat layer in poultry and wax coating on fresh produce that can prevent effective sanitation using conventional approaches as the coating material can repel water and reduce interaction of the sanitizer with food surface. Further enhanced contact of sanitizer to food surface is important as many food products have a relatively rough surface with micron scale features that can further limit inactivation of bacteria during conventional sanitation.

The influence of particle-based sanitizers on the quality of fresh produce after treatment was also analyzed. The results show that particle-based sanitizers had little effect on the net color change of leaf surfaces. After being washed by 5 ppm chlorine or mixture of chlorine and silica particles, a significant difference in color was observed between untreated and treated leaf samples. The color of fresh produce and meat samples was measured using the Hunter color value (L, a, b) values before and after treatment. The total color difference (ΔE) was determined to characterize the color changes.

In addition, exposure to antimicrobial particles for 20 min did not affect the maximum compression force between untreated and treated lettuce samples. Changes in texture of the samples is characterized based on the changes in maximum compression force (MCF) measured using the TA-TXPlus Texture Analyzer.

The shelf life (determined based on the quantitative color measurements and visual appearance) of both model fresh produce products sanitized using the conventional approach and the proposed particle-based sanitizers were measured under refrigerated storage. The enhanced reduction of the pathogenic bacteria and also natural spoilage microbes on food products using the methods will extend the shelf life of these products as compared to products with conventional sanitation.

### Example 6

The antimicrobial activity and associated cross-contamination prevention of functionalized sanitizer particle films were also evaluated. Films were prepared as generally shown in FIG. 3. Poly(vinyl alcohol-co-ethylene (PVA-co-PE) support films with cyanuric chloride linker were coupled with yeast cell wall or bran carrier particles with halamine as an antimicrobial agent.

To demonstrate the prevention or reduction of bacteria and other pathogens on fresh produce and poultry surfaces, contaminated leaves were brought in contact with a film with a one-hour time of exposure to produce a contaminated charged and uncharged films. A clean leaf and control and charged functionalized films were brought in contact with the contaminated films. The bacterial populations of the films after contact over time are shown in FIG. 7A and the bacterial populations of the leaves after contact are shown in FIG. 7B. It can be seen that cross-contamination is prevented or greatly reduced with contact with the halamine functionalized particle films depending on time of contact.

Biofilms represent the leading cause of cross-contamination of food and nonfood materials upon contact with contaminated surfaces. The formation of biofilms can significantly increase the antimicrobial resistance of bacterial cells and thus enhance the persistence of bacteria in complex biofilm structures.

The functionalized films were evaluated for the ability to prevent biofilm formation as well as a reduction or elimination of existing biofilms upon extended exposure to target bacteria. Recharging of the halamine functionality of the particles with bleach was also demonstrated.

The results of the antimicrobial treatments were evaluated using a combination of metabolic activity assays and multimodal microscopy. The multimodal microscopy approach was based on a combination of fluorescence microscopy and scanning electron microscopy (SEM) to characterize macroscale (millimeter-scale) and microscale (micrometer-scale) changes in biofilm ultrastructures.

The functionalized particle films showed strong inhibitory activity against pre-grown biofilm or prevented the growth of a new biofilm. The polymer film also maintained its antibiofilm activity after multiple cycles of exposure to high titers of bacterial load with recharging of the halamine particle film using bleach at intermediate steps between the cycles.

Accordingly, the rechargeable antimicrobial functionality of the film can be tailored by the selection of the carrier particle and antimicrobial agent. Such functionality can also be applied as surface coatings to many different surfaces such as plastics or metals.

From the description herein, it will be appreciated that that the present disclosure encompasses multiple embodiments which include, but are not limited to, the following:

1. A sanitizer composition, comprising: (a) a plurality of carrier particles; and (b) one or more antimicrobial agents loaded into, adsorbed onto or bonded to each carrier particle.

2. The composition of any preceding or following embodiment, wherein the carrier particle further comprises: a coupler configured to adsorb to or bond with the one or more antimicrobial agents.

3. The composition of any preceding or following embodiment, further comprising: a surface substrate; wherein the plurality of carrier particles are bound to the substrate.

4. The composition of any preceding or following embodiment, wherein the substrate further comprises a chemical linker, the linker coupling at least one carrier particle with the substrate.

5. The composition of any preceding or following embodiment, wherein the carrier particle is a particle selected from the group consisting of particles of wheat bran, rice bran, oat bran, hydrogel, and silica.

6. The composition of any preceding or following embodiment, wherein the carrier particle is selected from the group of particles consisting of a fungal cell, a plant cell, an algal cell, a microalgal cell, a yeast cell and a bacterial cell and fragments thereof.

7. The composition of any preceding or following embodiment, wherein the coupler of the carrier particle is selected from the group of a polymer, cellulose, a clay particulate and a zeolite particulate.

8. The composition of any preceding or following embodiment, wherein the polymer is a negatively charged polymer selected from the group consisting of sodium dodecyl sulfate (SDS), phospholipids, natural polymers and synthetic polymers.

9. The composition of any preceding or following embodiment, wherein the polymer is a polymer having a molecular weight in the range of about 0.5 kDa to about 500 kDa.

10. The composition of any preceding or following embodiment, wherein the one or more antimicrobial agents are selected from the group consisting of a halamine polymer, a quaternary ammonium compound, polymer comprising a quaternary group, hydrogen peroxide, metal ions, metal particles, a nitric oxide (NO) donor, an antibiotic agent and an antifungal agent.

11. The composition of any preceding or following embodiment, wherein the halamine polymer is from a polymer that has been exposed to chlorine, the polymer being selected from the group consisting of poly-ε-lysine, poly-L-lysine, polyethylenimine (PEI), 2,2,6,6-Tetramethyl-4-piperidinol (TMP), and a polyamine.

12. The composition of any preceding or following embodiment, wherein the NO donor is incorporated into or chemically linked to a polymer, the polymer selected from the group consisting of polyethylene glycol (PEG), polyurethane (PU), poly(methyl methacrylate) (PMMA), poly(vinyl pyrrolidone) (PVP), poly(amidoamine), poly(ethylene oxide), poly(propylene oxide), poly(vinyl chloride), polylactic acid (PLA), polyglycolic acid (PGA) and polylactic-co-glycolic acid (PLGA).

13. The composition of any preceding or following embodiment, wherein the NO donor is selected from the group consisting of a nitrate compound, a nitrite compound, a nitroso compound, an S-nitrosothiol, and a diazeniumdiolate.

14. The composition of any preceding or following embodiment, wherein the quaternary ammonium compound is selected from the group consisting of benzalkonium chloride, cetylpyridinium chloride, cetrimonium, cetrimide, dofanium chloride, tetraethylammonium bromide, didecyldimethylammonium chloride and domiphen bromide.

15. The composition of any preceding or following embodiment, wherein the polymer comprising a quaternary group comprises poly(N-alkyl-4-vinylpyridinium).

16. The composition of any preceding or following embodiment, wherein the metal ions are selected from the group consisting of copper ions and silver ions.

17. The composition of any preceding or following embodiment, wherein: the substrate comprises a film or surface of a poly(vinyl alcohol) based polymer; and wherein the linker comprises cyanuric chloride.

18. The composition of any preceding or following embodiment, wherein the composition is in the form of an emulsion, a film, a gel, a spray coating, a dip coating, a dispersion, a solution, or a combination thereof.

19. The composition of any preceding or following embodiment, wherein the film, gel, spray coating or dip coating comprises multiple layers.

20. The composition of any one of any preceding or following embodiment, wherein the emulsion, film, gel, spray coating, dip coating, dispersion or solution has a layer thickness in the range of about 100 nm to about 1 mm.

21. A method for eliminating bacterial or fungal pathogens in liquids and on surfaces, the method comprising: (a) fabricating a composition of a plurality of sanitizing particles, comprising: (1) a carrier; and (2) one or more antimicrobial agents loaded into, adsorbed onto or bonded to each carrier particle; and (b) exposing microbes to the antimicrobial agent of the particles.

22. The method of any preceding or following embodiment, further comprising: removing the plurality of sanitizing particles from the surface.

23. The method of any preceding or following embodiment, wherein the exposure of the microbes comprises: applying the plurality of sanitizing particles to a surface; and contacting microbes on the applied surface with the antimicrobial agent of the particles.

24. The method of any preceding or following embodiment, wherein the composition is in the form of an emulsion, a film, a gel, a spray coating, a dip coating, a dispersion, a solution, or a combination thereof.

25. The method of any preceding or following embodiment, further comprising: coating the surface with one or more layers of the emulsion, film, gel, spray coating or dip coating; wherein the coating layers form a continuous barrier on the surface.

26. The method of any preceding or following embodiment, wherein the coating of the emulsion, film, gel, spray coating, dip coating, dispersion or solution has a layer thickness in the range of about 100 nm to about 1 mm.

27. The method of any preceding or following embodiment, wherein the fabrication of the sanitizing particles comprises: loading one or more antimicrobial agents into cell wall or bran carrier particles using one or more modalities selected from positive pressure, negative pressure, osmotic pressure, diffusion, and combinations thereof.

28. The method of any preceding or following embodiment, wherein the fabrication of the sanitizing particles comprises: coupling one or more particulates of a polymer, a clay, a zeolite or cellulose to a carrier particle; and adsorbing or bonding one or more antimicrobial agents to the particulates coupled to the carrier particle.

29. A microbial cross-contamination resistant film, comprising: (a) a base substrate; (b) a support film joined to the base substrate; and (c) a plurality of sanitizing particles coupled to the support film, the particles comprising: (1) a carrier; and (2) one or more antimicrobial agents loaded into, adsorbed onto or bonded to each carrier particle; (d) wherein bacterial or fungal pathogens contacting the sanitizing particles are reduced or eliminated.

30. The film of any preceding or following embodiment, wherein the support film further comprises a chemical linker, the linker coupling at least one sanitizing particle with the support film.

31. The film of any preceding or following embodiment, the carrier of the sanitizing particles further comprising: a coupler configured to adsorb to or bond with the one or more antimicrobial agents.

32. The film of any preceding or following embodiment, wherein the coupler of the carrier is selected from the group of a polymer, cellulose, a clay particulate and a zeolite particulate.

33. A cell wall or bran particle or fragment thereof, comprising one or more antimicrobial agents loaded into, adsorbed onto or bound to (e.g., via covalent, ionic or hydrogen bonding) the cell wall or bran particle.

34. The cell wall or bran particle of any preceding or following embodiment, wherein the particle is from a fungal cell, a plant cell, an algal cell, a microalgal cell or a bacterial cell.

35. The cell wall or bran particle of any preceding or following embodiment, wherein the particle is from a yeast cell.

36. The cell wall or bran particle of any preceding or following embodiment, wherein the one or more antimicrobial agents are selected from the group consisting of a halamine polymer, a quaternary ammonium compound, polymer comprising a quaternary group, hydrogen peroxide, metal ions, metal particles, a nitric oxide (NO) donor, an antibiotic agent and an antifungal agent.

37. The cell wall or bran particle of any preceding or following embodiment, wherein metal ions are selected from copper ions and silver ions.

38. The cell wall or bran particle of any preceding or following embodiment, wherein the metal ions are bound to cellulose.

39. The cell wall or bran particle of any preceding or following embodiment, wherein the metal ions are part of nanostructures.

40. The cell wall or bran particle of any preceding or following embodiment, wherein the one or more antimicrobial agents are loaded into the cell wall or bran particle bound to or associated with a polymer having a molecular weight in the range of about 0.5 kDa to about 500 kDa.

41. The cell wall or bran particle of any preceding or following embodiment, wherein the one or more antimicrobial agents are adsorbed onto clay or zeolite, which is adsorbed onto the cell wall or bran particle.

42. A composition comprising a population of cell wall or bran particles of any preceding or following embodiment.

43. The composition of any preceding or following embodiment, wherein the composition is in the form of an emulsion, a film, a gel, a spray coating, a dip coating, dispersion, solution, or a combination thereof.

44. The composition of any preceding or following embodiment, wherein the film, gel, spray coating or dip coating comprises multiple layers.

45. The composition of any preceding or following embodiment, wherein the emulsion, film, gel, spray coating, dip coating, dispersion or solution has a thickness in the range of about 100 nm to about 1 mm.

46. The composition of any preceding or following embodiment, wherein the composition is transparent.

47. A food edible by a mammal, wherein the food is wholly or partially coated with a composition of any preceding or following embodiment.

48. The food of any preceding or following embodiment, wherein the food comprises fresh produce or meat.

49. The food of any preceding or following embodiment, wherein the composition forms a continuous barrier coating on the food.

50. A medical device or bandage wholly or partially coated with a composition of any preceding or following embodiment.

51. A container wholly or partially coated with a composition of any preceding or following embodiment.

52. The container of any preceding or following embodiment, wherein the container is a food container.

53. The container of any preceding or following embodiment, wherein the container is a beverage container.

54. The container of any preceding or following embodiment, wherein the container is a plastic container or a paper container.

55. A food preparation surface, food processing surface, or food packaging surface, wherein the surface is wholly or partially coated with a composition of any preceding or following embodiment.

56. A method of reducing or eliminating bacterial and/or fungal pathogens on a surface, comprising contacting the surface with a composition of any preceding or following embodiment under conditions sufficient to reduce or eliminate the bacterial and/or fungal pathogens.

57. The method of any preceding or following embodiment, wherein the method further comprises the step of rinsing the composition from the surface.

58. The method of any preceding or following embodiment, wherein the surface is on fresh produce or meat.

59. The method of any preceding or following embodiment, wherein the surface is on a container or medical device or bandage.

60. The method of any preceding or following embodiment, wherein the bacterial pathogen selected from the group consisting of Campylobacter, Helicobacter, Cholera, Cronobacter, Escherichia, Salmonella, Listeria, Lactococcus, Vibrio, Erwinia, Xanthomonas, Shigella, Staphylococcus, Streptococcus, Clostridium and Pseudomonas.

61. A method of making a cell wall or bran particle of any preceding or following embodiment, comprising loading into or adsorbing onto the cell wall or bran particle shell one or more antimicrobial agents.

62. The method of any preceding or following embodiment, wherein the one or more antimicrobial agents are associated with or bound to a polymer.

63. The method of any preceding or following embodiment, wherein the one or more antimicrobial agents are loaded into the cell wall or bran particles using one or more modalities selected from positive pressure, negative pressure, osmotic pressure, diffusion, and combinations thereof.

64. A method of reducing or eliminating bacterial or fungal pathogens on a surface, the method comprising: (a) applying a polymer support film on a surface; (b) coupling a plurality of sanitizing particles to the support film, the particles comprising: (1) a carrier; and (2) one or more antimicrobial agents loaded into, adsorbed onto or bonded to each carrier particle; (c) exposing microbes to the antimicrobial agents of the sanitizing particles; and (d) recharging the carrier with additional antimicrobial agents.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

TABLE 1
Pathogenic and Antibiotic Resistant Bacterial Strains

| Pathogenic strains | Antibiotic resistant strains |
|---|---|
| Escherichia coli | Escherichia coli O157:H7 |
| O157:H7 | (resistant to ampicillin) |
| Escherichia coli | Escherichia coli RM10809 |
| O145 | (resistant to ceftiofur, ampicillin, and |
| | cephalothin) |
| Listeria monocytogenes | Listeria monocytogenes 15313 |
| Scott A | (resistant to streptomycin) |
| Listeria monocytogenes | Listeria monocytogenes 10403S |
| 10403 | (resistant to streptomycin) |
| Salmonella typhimurium | Salmonella typhimurium DT104 |
| 14028 | (resistant to ampicillin, chloramphenicol, |
| | streptomycin, sulfamethoxazole, and |
| | tetracycline) |
| Salmonella enteritidis | Salmonella enteritidis 13076 |
| 4931 | (resistant to colistin, erythromycin, |
| | novobiocin and tetracycline) |

1. A sanitizer composition, comprising:
(a) a plurality of carrier particles; and
(b) one or more antimicrobial agents loaded into, adsorbed onto or bonded to each carrier particle.

2. The composition of claim 1, wherein said carrier particle further comprises:
a coupler configured to adsorb to or bond with said one or more antimicrobial agents.

3. The composition of claim 1, further comprising:
a surface substrate;
wherein said plurality of carrier particles are bound to the substrate.

4. The composition of claim 3, wherein said substrate further comprises a chemical linker, said linker coupling at least one carrier particle with said substrate.

5. The composition of claim 1, wherein said carrier particle is a particle selected from the group consisting of particles of wheat bran, rice bran, oat bran, hydrogel, silica, a fungal cell, a plant cell, an algal cell, a microalgal cell, a yeast cell and a bacterial cell and fragments thereof.

6. (canceled)

7. The composition of claim 2, wherein said coupler of said carrier particle is selected from the group of a polymer, cellulose, a clay particulate and a zeolite particulate.

8. The composition of claim 7, wherein said polymer is a negatively charged polymer selected from the group consisting of sodium dodecyl sulfate (SDS), phospholipids, natural polymers and synthetic polymers.

9. The composition of claim 7, wherein said polymer is a polymer having a molecular weight in the range of about 0.5 kDa to about 500 kDa.

10. The composition of claim 1, wherein the one or more antimicrobial agents are selected from the group consisting of a halamine polymer, a quaternary ammonium compound, polymer comprising a quaternary group, hydrogen peroxide, metal ions, metal particles, a nitric oxide (NO) donor, an antibiotic agent and an antifungal agent.

11. The composition of claim 10, wherein the halamine polymer is from a polymer that has been exposed to chlorine, the polymer being selected from the group consisting of poly-ε-lysine, poly-L-lysine, polyethylenimine (PEI), 2,2,6,6-Tetramethyl-4-piperidinol (TMP), and a polyamine.

12. The composition of claim 10, wherein the NO donor is incorporated into or chemically linked to a polymer, the polymer selected from the group consisting of polyethylene glycol (PEG), polyurethane (PU), poly(methyl methacrylate) (PMMA), poly(vinyl pyrrolidone) (PVP), poly(amidoamine), poly(ethylene oxide), poly(propylene oxide), poly(vinyl chloride), polylactic acid (PLA), polyglycolic acid (PGA) and polylactic-co-glycolic acid (PLGA).

13. The composition of claim 10, wherein the NO donor is selected from the group consisting of a nitrate compound, a nitrite compound, a nitroso compound, an S-nitrosothiol, and a diazeniumdiolate.

14. The composition of claim 10, wherein the quaternary ammonium compound is selected from the group consisting of benzalkonium chloride, cetylpyridinium chloride, cetrimonium, cetrimide, dofanium chloride, tetraethylammonium bromide, didecyldimethylammonium chloride and domiphen bromide.

15.-20. (canceled)

21. A method for eliminating bacterial or fungal pathogens in liquids and on surfaces, the method comprising:
(a) fabricating a composition of a plurality of sanitizing particles, comprising:
(1) a carrier; and
(2) one or more antimicrobial agents loaded into, adsorbed onto or bonded to each carrier particle; and
(b) exposing microbes to said antimicrobial agent of said particles.

22. (canceled)

23. The method of claim 21, wherein the exposure of the microbes comprises:
applying said plurality of sanitizing particles to a surface; and
contacting microbes on the applied surface with said antimicrobial agent of said particles.

24. The method of claim 21, wherein the composition is in the form of an emulsion, a film, a gel, a spray coating, a dip coating, a dispersion, a solution, or a combination thereof.

25. The method of claim 24, further comprising:
coating said surface with one or more layers of said emulsion, film, gel, spray coating or dip coating;
wherein the coating layers form a continuous barrier on the surface.

26. The method of claim 24, wherein the coating of said emulsion, film, gel, spray coating, dip coating, dispersion or solution has a layer thickness in the range of about 100 nm to about 1 mm.

27. The method of claim 21, wherein the fabrication of said sanitizing particles comprises:
loading one or more antimicrobial agents into cell wall or bran carrier particles using one or more modalities selected from positive pressure, negative pressure, osmotic pressure, diffusion, and combinations thereof.

28. The method of claim 21, wherein the fabrication of said sanitizing particles comprises:
coupling one or more particulates of a polymer, a clay, a zeolite or cellulose to a carrier particle; and
adsorbing or bonding one or more antimicrobial agents to said particulates coupled to said carrier particle.

29. A microbial cross-contamination resistant film, comprising:
(a) a base substrate;
(b) a support film joined to the base substrate; and
(c) a plurality of sanitizing particles coupled to the support film, said particles comprising:
(1) a carrier; and
(2) one or more antimicrobial agents loaded into, adsorbed onto or bonded to each carrier particle; and
(d) wherein bacterial or fungal pathogens contacting the sanitizing particles are reduced or eliminated.

30. The film of claim 29, wherein said support film further comprises a chemical linker, said linker coupling at least one sanitizing particle with said support film.

31. The film of claim 29, said carrier of said sanitizing particles further comprising:
a coupler configured to adsorb to or bond with said one or more antimicrobial agents, said coupler selected from the group of a polymer, cellulose, a clay particulate and a zeolite particulate.

32-33. (canceled)
